(19) United States
(12) Patent Application Publication
(10) Pub. No.: US 2016/0363048 A1
(43) Pub. Date: Dec. 15, 2016

(54) GAS TURBINE ENGINE

(71) Applicant: ROLLS-ROYCE plc, London (GB)

(72) Inventor: Ahmad M RAZAK, Bristol (GB)

(73) Assignee: ROLLS-ROYCE plc, London (GB)

(21) Appl. No.: 15/151,787

(22) Filed: May 11, 2016

(30) Foreign Application Priority Data
Jun. 11, 2015 (GB) 1510167.8

(51) Int. Cl. F02C 3/14; F02C 3/06; F02C 6/20; F02C 9/18; F02C 3/107; F02C 6/00

(52) U.S. Cl. CPC F02C 3/14; F02C 3/107; F02C 6/003; F02C 6/20; F02C 9/18; F02C 3/06; F05D 2220/323; F05D 2260/96

(57) ABSTRACT

A gas turbine engine includes an air intake and propulsive fan that generates two airflows A and B. Gas turbine engine includes, in axial flow A, core including a compressor, first combustor, high pressure turbine including first turbine stage, second combustor, second turbine stage of the high pressure turbine, low pressure turbine and core exhaust nozzle including and divergent portions. Fan housing surrounds the core and fan and defines, in axial flow B, a bypass arrangement including the fan, a duct, a third combustor in the form of a duct burner and a bypass nozzle including a converging portion and a diverging portion. The bypass and core are arranged coaxially, such that the core flow A is exhausted annularly within the bypass flow. When the duct burner is in operation, the exhaust velocity of the bypass flow is greater than the exhaust velocity of the core flow.

### FIELD OF THE INVENTION

The present invention relates to a gas turbine engine and a method of operating a gas turbine engine. Particularly, though not exclusively, the invention relates to gas turbine engines for use in aircraft.

### BACKGROUND TO THE INVENTION

There is a continual need to decrease the fuel consumption of aircraft gas turbine engines (for example, in terms of Specific Fuel Consumption (SFC)), in order to save operating costs, and to reduce their environmental impact due to carbon emissions and nitrous oxide (NOx). Another requirement is to reduce perceived noise of aircraft engines in operation, both to the passengers and members of the public on the ground. These requirements are particularly pronounced for Super-Sonic Business Jets (SSBJs), which need to have long range and low operating costs (and so low SFC), low noise on takeoff so that they can operate close to urban areas, and high cruise efficiency at supersonic speeds. The noise requirements at takeoff would imply a large bypass ratio (and so a low specific thrust, i.e. a low ratio of net thrust/total intake airflow), whereas the fuel efficient supersonic cruise requirement would imply a high specific thrust. There is also a requirement in such aircraft to keep other environmental impacts to a minimum, and so it is desirable to minimise nitrogen oxide (NOₓ) and water vapour emissions.

In order to address the noise issue, the “Variable Stream Control Engine” (VSCE) has been proposed. The VSCE comprises a relatively low bypass gas turbine engine having a “duct burner” or “augmenter” comprising a combustor located in the bypass flow and a downstream nozzle configured to accelerate the bypass flow. The combustor and nozzle increase the velocity of air exiting the bypass flow, thereby creating an “inverted velocity profile”, whereby the bypass flow has a greater velocity than the core flow. This has been thought to reduce noise by as much as 8 dB compared to a conventional bypass engine. However, this solution is relatively inefficient, with SFC being increased when the augmenter is operated. It is thought that, in order to obtain supersonic speeds, an aircraft employing such a system would have to utilise the augmenter both on takeoff and during cruise, resulting in high SFC. Such a system is described in Richard W. Hines. “Variable Stream Control Engine for Supersonic Propulsion”, Journal of Aircraft, Vol. 15, No. 6 (1978), pp. 321-325.

Gas turbine engines comprising “sequential” combustors have been proposed for use in electricity production. Examples include the GT24 gas turbine engine produced by Alstom™. In such gas turbine engines, a second combustor is provided downstream of a first combustor between upstream and downstream turbines. Such an arrangement is described for example in U.S. Pat. No. 5,941,060.

Sequential combustors have also been proposed for aircraft gas turbine engines, particularly for military aircraft, for example in “Two-combustor Engines’ Performances under Design and Off-design Conditions” by A S Lee, R Singh and S D Probert, presented at the 45^{th} AIAA/ASME/SAE/ASEE Joint Propulsion Conference and Exhibit in August 2009. However, previous studies have only found arrangements which can be expected to have increased SEC compared to gas turbines having conventional combustors.

Another difficulty is found in operating gas turbine engines efficiently across a wide range of thrust/power levels. Generally, gas turbine engines have a “design point” at or close to their maximum power at which they produce power most efficiently. At power levels below this design point (so called “off design conditions”), power is produced significantly less efficiently. This is the case for example in gas turbine engines used in civil aircraft, in which the required thrust varies across different phases of flight, and also in gas turbine electrical generators or gas turbines in use in ships, in which reduced power may be required in some circumstances. Single spool gas turbine engines can operate at reduced power relatively efficiently by varying the position of inlet guide vanes upstream of the compressor, thereby allowing operation at a substantially constant turbine entry temperature across a wide range of conditions.

However, such operation is not generally practical in multi-spool gas turbines having several compressors driven by separate turbines, as this would require variable geometry turbines or exhaust nozzles.

It has also been found that, in supersonic aircraft, significant energy is lost in the engine inlet, as air is slowed down to subsonic speeds for compression in the compressor. Consequently, supersonic aircraft are relatively inefficient compared to sub-sonic aircraft, which may reduce their range, increase operating costs, and increase environmental damage produced by such aircraft.

The present invention describes a gas turbine engine which seeks to overcome some or all of the above problems.

### SUMMARY OF THE INVENTION

According to the present invention, there is provided a gas turbine engine comprising a core, the core comprising:

a first compressor coupled to a first turbine, the first turbine having first and second turbine stages coupled to the first compressor by a first shaft;

a first combustor located downstream of the first compressor and upstream of the first stage of the first turbine;

a second combustor located downstream of the first stage of the first turbine, and upstream of the second stage of the first turbine; and

a further turbine downstream of the first turbine;

the gas turbine engine further comprising a bypass arrangement comprising:

a bypass fan upstream of the first compressor coupled to the further turbine by a further shaft;

a third combustor located in a bypass flow path downstream of the fan; and

a bypass nozzle configured to accelerate bypass exhaust flow to a velocity greater than core exhaust flow when the third combustor is in operation.

It has been surprisingly found by the inventor that the above arrangement results in a gas turbine engine having improved SFC under a wide range of off design conditions, in some cases by as much as 8% SFC for a supersonic flight cycle compared to a comparable single combustor gas turbine engine. Due to the relative high efficiency under off design conditions, the core can be throttled down during takeoff, with additional thrust being provided by the third combustor and nozzle, thereby decreasing noise on takeoff without detrimentally affecting fuel economy. At cruise, the third combustor would typically be inoperative, with the core (i.e. the first and second combustors) operated at high power, thereby providing high efficient supersonic cruise.

At least the first combustor may be configured to provide complete combustion of fuel entering the combustor, such that substantially no combustion occurs in the turbine. The first and/or second combustor may comprise an isobaric combustor configured to provide substantially no pressure drop from the entry to the exit of the combustor.

Any of the first, second and third combustors may comprise one of a rich quick quench combustor and a lean burn combustor. In one example, the first combustor may comprise a rich quick quench combustor, and the second combustor may comprise a lean burn combustor.

The third combustor may comprise a rich burn combustor, and may comprise an annular combustor. Alternatively, the third combustor may comprise a rich burn quick quench combustor or a lean burn combustor.

The bypass nozzle may comprise a de Leval nozzle, comprising a convergent portion upstream of a divergent portion. The bypass nozzle may comprise a first actuator configured to vary throat area, and may comprise a second actuator configured to vary exit area

The core may comprise a core nozzle configured to accelerate core exhaust downstream of the further turbine. The core nozzle may comprise a de Leval nozzle. the core nozzle may comprise a first actuator configured to vary throat area, and may comprise a second actuator configured to vary exit area. The core nozzle may be located downstream of the bypass nozzle.

The gas turbine engine may comprise first and second further turbines coupled to respective first and second further shafts, wherein a further compressor may be coupled to the first further shaft, and the fan may be coupled to the second further shaft.

At least the first turbine stage of the first turbine may comprise a metallic material, and may comprise an internal cooling arrangement. The second turbine stage may comprise a ceramic material, and may not be provided with an internal cooling arrangement. It has been found that further benefits can be provided where at least the second turbine is not internally cooled. Alternatively, both the first and second turbine stages may comprise ceramic materials and may be uncooled.

The first combustor may comprise a lean burn combustor, and may comprise a pre-mixed combustion combustor. Advantageously, since the first combustor can be operated at substantially constant exit temperatures during most operating conditions, a lean burn combustor can be more easily implemented without the use of a stabilising diffusion flame. This may result in lower nitrous oxide (NOₓ) emissions. The second combustor may also comprise a lean burn or diffusion flame combustor.

At least one of the first combustor and second combustor may comprise a cooling system configured to provide cooling air to the respective combustor from one of the compressors. The cooling air for the second combustor may be delivered from a compressor stage upstream of the compressor stage from which the cooling air for the first combustor is delivered. Advantageously, thermodynamic losses from cooling the second combustor are minimised.

Alternatively, the first combustor only may comprise a cooling system. The second combustor may be uncooled, and comprise a high temperature ceramic material. In a still further alternative, both the first and second combustors may be uncooled.

### BRIEF DESCRIPTION OF THE DRAWINGS

FIG. 1 shows a schematic sectional view of a gas turbine engine in accordance with the present disclosure;

FIG. 2 shows a part of the gas turbine engine of FIG. 1; and

FIG. 3 shows a further part of the gas turbine engine of FIG. 1.

### DETAILED DESCRIPTION

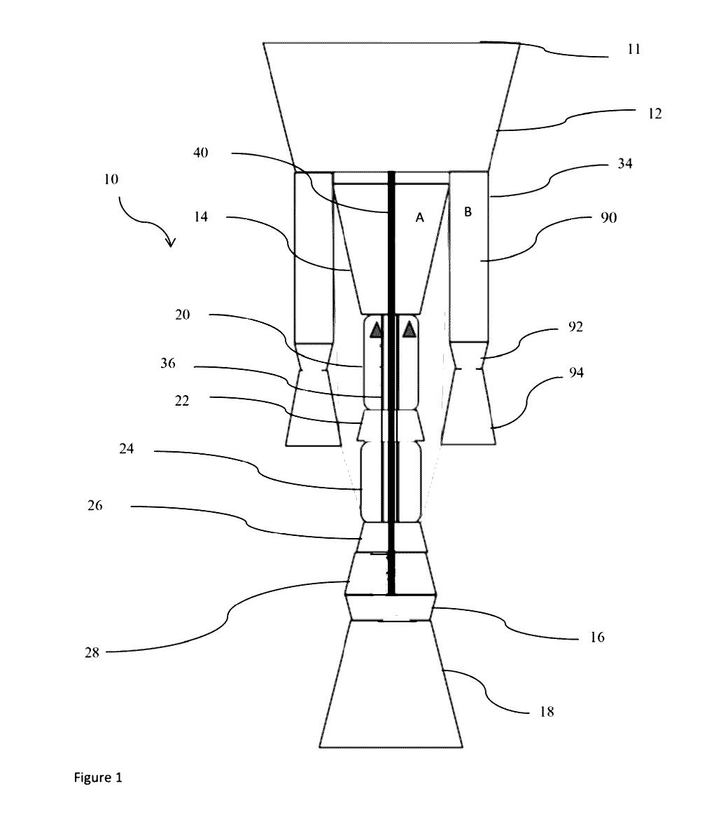

FIGS. 1 to 3 show a gas turbine engine 10. The gas turbine engine 10 comprises an air intake 11 and a propulsive fan 12 that generates two airflows A and B. The gas turbine engine 10 comprises, in axial flow A, a core comprising a compressor 14, a first combustor 20, a high pressure turbine comprising a first turbine stage 22, a second combustor 24, a second turbine stage 26 of the high pressure turbine, a low pressure turbine 28 and a core exhaust nozzle comprising 16 and divergent 18 portions. A fan housing surrounds the core and fan 12 and defines, in axial flow B, a bypass arrangement comprising the fan 12, a duct 34, a third combustor in the form of a duct burner 90 and a bypass nozzle comprising a variable converging portion 92 and a diverging portion 94. The bypass and core are arranged coaxially, such that the core flow A is exhausted annularly within the bypass flow B.

The fan 12 may comprise a multi-stage, relatively high pressure fan, comprising a plurality of axial compressor stages. The fan 12 may comprise variable geometry, comprising variable stator vanes configured to vary their respective angles of incidence in accordance with a schedule.

The duct burner 90 comprises a conventional rich burn combustor. The first and second stages 22, 26 of the high pressure turbine are coupled to the 14 by a first shaft 36. The low pressure turbine 28 is coupled to the fan 12 by a further shaft 40 arranged coaxially within the first shaft 36.

The core and fan flows A, B are sized to provide a bypass ratio of approximately 2:1. That is to say, that the mass of air in flow A that flows through the bypass duct 36 is approximately twice the mass of air flow B that flows through the core at any given engine conditions.

The fan 12 and compressor 14 are designed for an Overall Pressure Ratio (OPR) at top of claim (TOC) of approximately 30:1, at which point the aircraft is typically travelling at an altitude of approximately 30,000 feet or higher and supersonic speeds. The OPR will be understood to refer to the ratio of the stagnation pressure at the front of the fan 12, to the stagnation pressure of the exit of the high pressure compressor 14. The invention has been found to be particularly suitable at OPRs of approximately 30 or above. This is because at such OPR and cruising at about Mach 2, irreversibility effects in the thermodynamic processes (e.g. component inefficiency in the inlet, compression and expansion processes) dominate the efficiency calculation. Consequently, it has been found that the engine 10 of the present disclosure may have a higher thermal efficiency compared to the prior art engines in these conditions and a greater specific work (i.e. the core can generate more power for a given mass of fuel burnt in the engine), thereby driving the SFC of the engine 10 down. The high pressure turbine is designed for a relatively low pressure ratio of approximately 1.75.

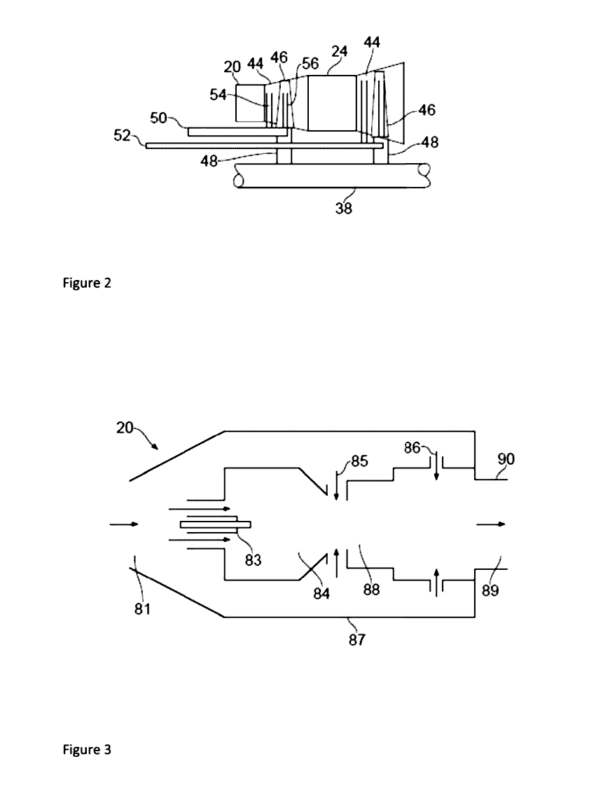

The high pressure turbine and second combustor 24 are shown in further detail in FIG. 2. Each of the first and second stages 22, 26 of the high pressure turbine comprises a respective stationary nozzle guide vane (NGV) 44 and a set of rotating turbine blades 46 (only one of which is shown for clarity) downstream of the respective NGV 44. Each NGV 44 is arranged to direct gas to the respective downstream blade 46 at a required angle for efficient operation of the turbine blade 46. Gas impinging on the turbine blade 46 causes the blade 46 to rotate, thereby turning the first shaft 38 via a respective disc 48 to which the respective blades 46 are attached. However, it will be understood that the turbine 26 need not include variable stators in this configuration, which is required by reheat turbines on different shafts.

The engine 10 comprises a cooling arrangement configured to cool components of the engine to prevent the materials from which the engine is made from melting or softening as a result of the high temperatures produced by combustion.

Referring to FIG. 2, the cooling system comprises a first cooling duct 50 which receives air from the compressor 14 discharge, and provides this air to the first combustor 20 to provide dilution air to the combustor 20 during operation.

The cooling system further comprises a second cooling duct 51, which provides cooling air to the first stage 22 of the high pressure turbine.

Referring again to FIG. 2, the blades 46 and NGVs 44 of the first stage 22 of the high pressure turbine comprise internal cooling channels 54, 56. The channels 54, 56 receive high pressure cooling from the second cooling duct 52. The NGVs and blades 44, 46 may also include cooling holes (not shown) on external surfaces of the NGVs and blades 44, 46 which communicate with the channels 54, 56 to provide external film cooling. A similar arrangement cools the vanes 44 and blades 46 of the second turbine stage.

An optional third cooling duct may be provided, which provides cooling air to the second combustor 24. This air is taken from a lower pressure stage of the high pressure compressor 18 compared to the air provided to the first cooling duct 50. However, it is thought that this cooling flow represents approximately 20% of core air flow, and consequently represents a significant proportion of core air flow which is partially lost to the thermodynamic cycle of the engine. Consequently, the second combustor 24 may be made of a material having a high melting point such as ceramic, such that cooling air is not necessary, in which case the third cooling duct can be omitted. This is advantageous, since deletion of the third cooling duct would greatly simplify the secondary air system within the engine 10, and may result in increased SFC due to the reduce demand for bleed air from the compressor 14.

An optional fifth cooling duct may also be provided to provide cooling air to the low pressure turbine 28 in a similar manner to the duct 52. Again, this fifth cooling duct can be omitted by the use of high temperature materials in the low pressure turbine 28.

The engine 10 is operated according to one of a first operating method and a second operating method in dependence on a selected flight phase of the aircraft on which the engine 10 is flown.

In the first mode, corresponding to the take-off flight phase, the engine 10 is operated as follows. In order to provide sufficient thrust to permit takeoff, the engine must be operated at high power. Simultaneously, it is desirable to reduce noise levels on the ground and within the aircraft cabin. Consequently, each of the first, second and third combustors 20, 24, 90 are operated such that fuel is supplied to each combustor 20, 24, 90, and burnt therein to provide thrust. The third combustor 90 loading is held constant while the second combustor 24 loading (i.e. the exit temperature of the combustor 24) is altered to achieve the required thrust as stipulated by rating during take-off and climb. The burnt combustion products in flows A and B flow downstream to the respective convergent portions 16, 92 of the respective nozzles. At this point, the flow is generally sub-sonic or transonic. As the flow progresses to the respective convergent portion 16, 92 the flow is accelerated, and the pressure falls, in accordance with Bernouli's principle. The flow accelerates until it reaches sonic velocity (i.e. Mach 1), wherein the flow is said to be choked. The supersonic flow then continues into the respective divergent portion 18, 94, where the flow is again accelerated to supersonic velocities.

The bypass nozzle and duct burner 90 are configured to accelerate the bypass exhaust flow B to a higher velocity than exhaust flow A velocity of the core nozzle when the duct burner 90 is in operation. This may for example be achieved by employing a duct burner 90 providing a sufficiently large temperature increase to the bypass flow B when in operation, and/or the divergent portion 94 having a higher expansion ratio than the divergent portion 18. Consequently, a layer of high velocity air is produced surrounding the core flow, and so noise from shear between the core flow A and bypass flow B is reduced. Consequently, takeoff noise is reduced significantly. In general, bypass exhaust flows B having a velocity around 50% to 70% higher than the core exhaust flow (with duct burners on) A velocity have been found to be effective in significantly reducing take-off noise.

In many cases, it may be desirable to reduce the thrust produced during takeoff considerably, for example where the aircraft is operated at low weights, or where a long runway is available. Such operation may reduce engine wear. Alternatively or in addition, noise from the core flow A can be reduced by operating the core at reduced power during takeoff. In such circumstances, the second combustor 24 is operated at lower power, by reducing fuel flow, while the first and third combustors 20, 90 are operated at substantially full power. It has been found that the engine 10 of the presently described arrangement can operate efficiently at cruise (both supersonic and subsonic) and reduced thrust takeoff, i.e. in “off design” conditions. Consequently, this reduced core flow A can be provided without experiencing significant decreases in fuel efficiency.

In general, in the first operating mode, the third combustor 90 is operated at maximum load. This is determined by the inlet combustion air temperature and air flow, which is determined by an algebraic expression such that the duct burner 90 exit temperature is 1900K (in one example). This will ensure low NOx emissions.

In a second operating mode, corresponding to the climb and cruise phase of flight, the engine 10 is operated as follows. The first and second combustors 20, 24 are operated only, with fuel not being supplied to the third combustor 90. Consequently, thrust is produced by both the core and bypass flows A, B. However, the bypass flow B is not accelerated to the same extent as previously, as the lack of combustion in the third combustor 90 causes the flow B to enter the convergent portion 92 at a lower velocity. Consequently, core exhaust flow A velocity exceeds bypass exhaust flow B velocity, and noise is increased. However, noise is considered less problematic during climb and cruise, since the aircraft is at a higher altitude, and therefore further from the public.

Meanwhile, since the engine operates at a higher efficiency when the first and second combustors 20, 24 only are operated, the overall SFC of the engine 10 is reduced.

Again, where reduced thrust is required (for example for descent or for subsonic cruise), the second combustor 24 is operated at reduced temperatures (by reducing fuel flow to the second combustor 24), while the first combustor 20 is operated at maximum temperature. Consequently, a wide range of thrust can be produced efficiently, without recourse to the use of inefficient core afterburners or duct burners throughout the majority of the flight. Where still further thrust reductions are required (such as during descent), fuel flow can be reduced to the first combustor 20, to thereby lower the temperature therein.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

For example, an afterburner could be provided downstream of the low pressure turbine and upstream of the core nozzle, for providing additional thrust when operated.

The gas turbine engine could be operated in accordance with different operating methods.

The third combustor could comprise a lean burn combustor. Advantageously, a lean burn combustor generally produces less NOₓ compared to a rich burn combustor. Since the third combustor may not require throttling, a suitable lean burner could be constructed which would be relatively simple, lightweight and inexpensive. For example, one or more of the first, second and third combustors could comprise a rich burn quick quench (RQL) combustor or a lean burn combustor.

Additional equipment such as thrust reversers could be included. The exhaust flows A and B could be combined into a single exhaust flow within a nacelle extending downstream of both convergent-divergent nozzles. Either or both nozzles could comprise an ejector configured to entrain air into the exhaust stream within the respective nozzle.

Aspects of any of the embodiments of the invention could be combined with aspects of other embodiments, where appropriate.

1. A gas turbine engine comprising a core defining a core flow path, the core comprising:
a first compressor coupled to a first turbine, the first turbine having first and second turbine stages coupled to the first compressor by a common first shaft;
a first combustor located downstream in the core flow path of the first compressor and upstream of the first stage of the first turbine;
a second combustor located downstream in the core flow path of the first stage of the first turbine, and upstream of the second stage of the first turbine; and
a further turbine downstream of the first turbine coupled to a further compressor by a further shaft;
the gas turbine engine further comprising a bypass arrangement defining a bypass flow path, the bypass arrangement comprising:
a bypass fan upstream of the first compressor coupled to the further turbine by the further shaft;
a third combustor located in the bypass flow path downstream of the fan; and
a bypass nozzle configured to accelerate bypass exhaust flow to a velocity greater than core exhaust flow when the third combustor is in operation.

2. A gas turbine engine according to claim 1, wherein the first combustor is configured to provide complete combustion of fuel entering the combustor, such that substantially no combustion occurs in the turbine.

3. A gas turbine engine according to claim 2, wherein the first and/or second combustor comprises an isobaric combustor configured to provide substantially no pressure drop from the entry to the exit of the combustor.

4. A gas turbine engine according to claim 1, wherein the first combustor comprises a rich quick quench combustor, and the second combustor comprises a lean burn combustor.

5. A gas turbine according to claim 1 wherein the third combustor comprises either a lean or a rich quick quench combustor.

6. A gas turbine engine according to claim 1, wherein the bypass nozzle comprises a variable geometry convergent portion upstream of a divergent portion.

7. A gas turbine engine according to claim 1, wherein the core comprises a core nozzle configured to accelerate core exhaust downstream of the further turbine.

8. A gas turbine engine according to claim 1, wherein the gas turbine engine comprises first and second further turbines coupled to respective first and second further shafts, and wherein a further compressor is coupled to the first further shaft, and the fan is coupled to the second further shaft.

9. A gas turbine engine according to claim 1, wherein the first turbine stage of the first turbine comprises a metallic material, and comprises an internal cooling arrangement.

10. A gas turbine engine according to claim 1, wherein the second turbine stage comprises a ceramic material.

11. A gas turbine engine according to claim 1, wherein at least one of the first combustor and second combustor comprises a cooling system configured to provide cooling air to the respective combustor from one of the compressors.

12. A gas turbine engine according to claim 11, wherein the first combustor comprises a cooling system, and the second combustor is uncooled.

13. A gas turbine engine according to claim 12, wherein the second combustor comprises a high temperature ceramic material.
